(19) United States
(12) Patent Application Publication
(10) Pub. No.: US 2018/0247331 A1
(43) Pub. Date: Aug. 30, 2018

(54) WAIT TIME AVOIDANCE

(71) Applicant: Panasonic Intellectual Property Management Co., Ltd., Osaka (JP)

(72) Inventor: Michael Glynn D'ANDREA, Burlington, VT (US)

(21) Appl. No.: 15/906,590

(22) Filed: Feb. 27, 2018

Related U.S. Application Data
(60) Provisional application No. 62/464,694, filed on Feb. 28, 2017.

(51) Int. Cl. G06Q 30/02; G06K 9/00

(52) U.S. Cl. CPC G06Q 30/0239; G06Q 30/0211; H04N 7/183; G06K 9/00778; G06K 9/00362; G06Q 30/0269

(57) ABSTRACT

A system for wait time avoidance may include a video imaging device that captures one or more images of an area and a server that analyzes the captured images to identify that a number of patrons in the area has met a predetermined threshold, categorizes the patrons in the area based on a predetermined set of characteristics, identifies an incentive for at least one category of patrons, and transmits a notification to the active communication device regarding the identified incentive.

### RELATED APPLICATIONS

This application claims priority to U.S. provisional application No. 62/464,694 filed on Feb. 28, 2017, the entire contents of which are incorporated herein by reference.

### BACKGROUND

### Field of Invention

The present disclosure generally relates to wait times. In particular, the present disclosure relates to wait time avoidance.

### Description of the Related Art

Many theme parks, resorts, and similar types of service providers make available a variety of attractions, games, and other locations or activities or interest to their guests. Some of these attractions may be very popular with the guests, leading to long line and associated wait times in order to experience or participate in the attraction. Such long lines and wait times are an inconvenience to the guests, however, leading to a less optimal guest experience.

To improve guest experience, some service providers may provide expedited “Fastpass” programs that involve obtaining passes for popular attractions ahead of time and showing up at a designated time. Such programs—which are generally specific to attractions known or expected to be popular (e.g., a new attraction)—allow the guest to visit other, perhaps less popular attractions during what would otherwise be a wait time and to return to the popular attraction later. While such programs are directed at avoiding the experience of standing and waiting in a line, such programs do not otherwise influence where the guests go or do in a way that may even further enhance the guest experience.

There is, therefore, a need in the art for improved systems and methods for wait time avoidance.

### SUMMARY OF THE CLAIMED INVENTION

Embodiments of the present invention include systems and methods for wait time avoidance. An exemplary system for wait time avoidance may include a camera that captures one or more images of an area and a server that analyzes the captured images to identify that a number of patrons in the area has met a predetermined threshold, categorizes the patrons in the area based on a predetermined set of characteristics, identifies an incentive for at least one category of patrons, and transmits a notification to the active communication device regarding the identified incentive.

### BRIEF DESCRIPTION OF THE DRAWINGS

FIG. 1 illustrates an exemplary network environment in which a system for wait time avoidance may be implemented.

FIG. 2 is a flowchart illustrating an exemplary queue minimization method for wait time avoidance.

FIG. 3 is a flowchart illustrating an exemplary patron categorization method for wait time avoidance.

FIG. 4 is a flowchart illustrating an exemplary incentive redemption method for wait time avoidance.

FIG. 5 illustrates an exemplary set of entries in an incentive acceptance database that may be used in a system for wait time avoidance.

FIG. 6 illustrates an exemplary computing system (i.e. user device) that may be used to implement an embodiment of the present invention.

### DETAILED DESCRIPTION

Embodiments of the present invention include systems and methods for wait time avoidance. An exemplary system for wait time avoidance may include a camera that captures one or more images of an area and a server that analyzes the captured images to identify that a number of patrons in the area has met a predetermined threshold, categorizes the patrons in the area based on a predetermined set of characteristics, identifies an incentive for at least one category of patrons, and transmits a notification to the active communication device regarding the identified incentive.

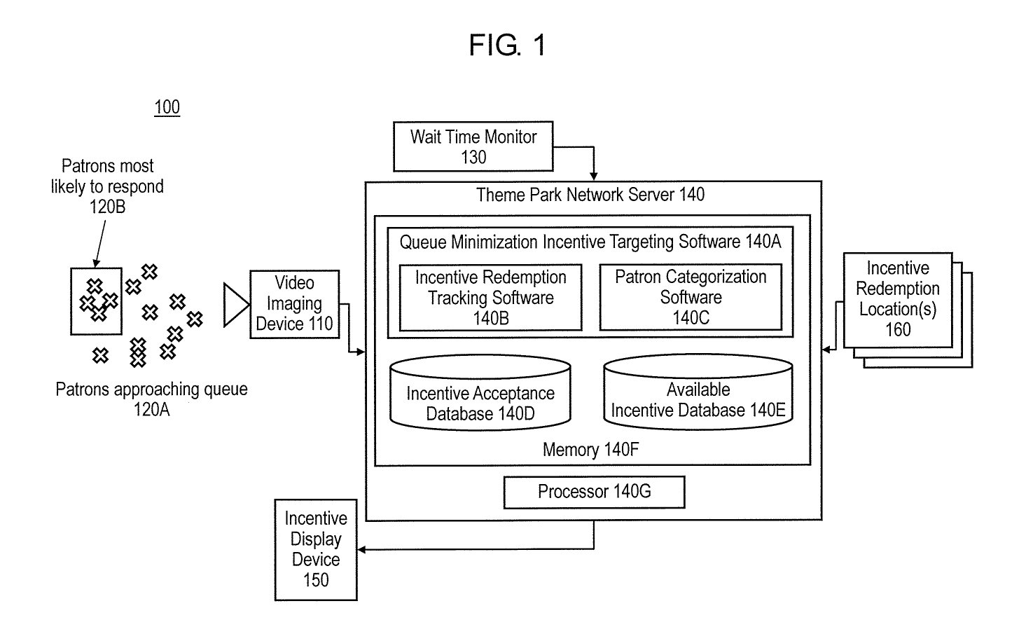

FIG. 1 illustrates an exemplary network environment 100 in which a system for wait time avoidance may be implemented. Network environment 100 may include one or more video imaging devices 110 (e.g., at an attraction waiting area) directed at patrons 120, a wait time monitor 130, a theme part network server 140, one or more incentive display devices 150, and one or more incentive redemption location devices 160. Such a system allows for monitoring attractions in a theme park in a way that enables identification of when the wait time is too long (e.g., meets a predetermined threshold) and identify that patrons approaching the attraction queue may be likely to respond to an incentive to go to a different attraction.

Video imaging devices 110 may be include any type of camera known in the art for capturing images, including still and video images. The imaging devices 110 may be located nearby an attraction and be directed at the waiting area of the attraction. The view of the imaging devices 110 may further include any paths or spaces around the waiting area so as to capture images of patrons 120 approaching the waiting queue.

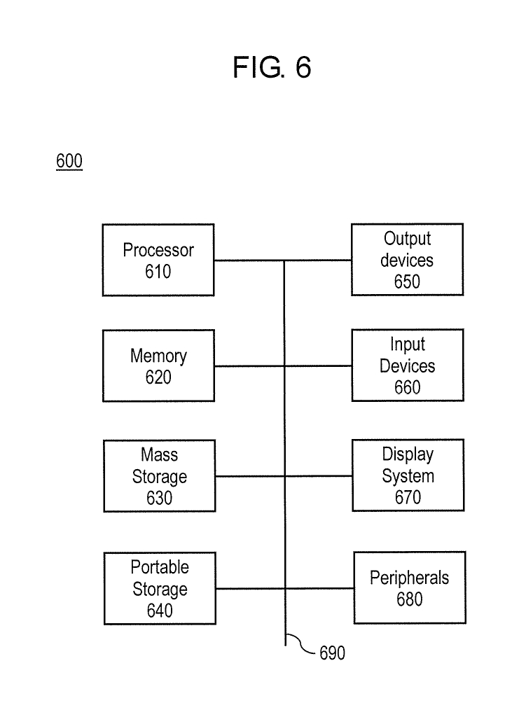

The patrons 120 may include patrons who are approaching the queue 120A, a group within which may include a subgroup of patrons deemed most likely to respond to an incentive to go to another attraction 120B. Each patron 120 may each be associated with a user device that may be used to communicate with the patron 120 regarding incentives. Such a user device may be any type of communication device known in the art, including general purpose computers, pagers, mobile phones, smartphones, personal digital assistants (PDAs), portable computing devices (e.g., laptop, netbook, tablets), desktop computing devices, handheld computing device, or any other type of computing device capable of communicating over communication networks. User device may be inclusive, for example, of a computing device such as described with respect to FIG. 6 herein.

Wait time monitors 130 may be a computing device—which may include that described in detail with respect to FIG. 6—that specifically programmed to determine a wait time based on such factors as number of users approaching a line, number of users currently in line, a time associated with experiencing the attraction, capacity of the attraction, frequency of mechanical failure, etc. As such, wait time monitor 130 may communicate with imaging device 100 and other sensors to obtain information regarding such factors. Wait time monitor 130 may then provide an estimated current wait time associated with a given attraction to theme park network server 140.

Theme park network server 140 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Alternatively, the server may include a distributed computing system. Any of the aforementioned servers (or an integrated server) may take on certain client-side, cache, or proxy server characteristics. These characteristics may depend on the particular network placement of the server or certain configurations of the server.

Theme park network server 140 may include queue minimization targeting software 140A (which includes incentive redemption tracking software 140B and patron categorization software 140C), incentive acceptance database 140D, and available incentive database 140E. The foregoing software and databases may reside in memory 140F and the software executed by processor 140G.

The queue minimization incentive targeting software 140A may continually be polling for information from the wait time monitor 130. When the wait time as determined by wait time monitor 130 meets a predetermined threshold (e.g., 30 minutes), the queue minimization incentive targeting software 140A may begin polling the video imaging device 120 for patron(s) 120 approaching the attraction queue. Once a patron 120 is detected by the video imaging device 110, the patron categorization software 140C may be executed to determine whether each approaching patron is likely to respond to an incentive offer.

Patron categorization software 140C may analyze the image captured by imaging device 110 with respect to identifying certain demographic or other characteristic information, such as age, race, gender, clothing (e.g., favorite colors or color schemes, logos/brands, themed items, costumes, etc.). Facial analysis, for example, may be performed on an image of the face of a patron 120. Facial analysis may include identifying the existence (or not) of a face or facial region in the captured image. If a face/facial region is detected, then patron categorization software 140C may further be executed to determine one or more characteristics related to the image, such as gender and/or age (or age range), facial expressions, etc. Once facial analysis has been performed, patron characteristic data may be generated based on the facial analysis. Such characteristic information indicates, for example, whether a certain patron 120 is a fan of certain cartoon or action characters such that an incentive related to such characters may be of interest.

The incentive acceptance database 140D may keep track of each incentive offered, what patron characteristic prompted the software to offer that incentive, and if that incentive was redeemed. The available incentive database 140E may be populated by the theme park management with incentives currently available to the queue minimization incentive targeting software 140A.

Incentive redemption data may be retrieved from incentive acceptance database 140D. The patron characteristic data may then be compared with a redemption rates and other profiles in the incentive acceptance database 140D to generate a recommendation as to one or more incentives. One or more incentives may be selected to present to the patron based, inter alia, on a comparison of the recommended incentive profiles. The selection of the incentive(s) may be based on a weighing and/or ranking of the various selection criteria. The selected incentive(s) may then be displayed to the patron 120 on the incentive display device 150, which may be any type of display screen for displaying information to the patrons 120.

Redemption location device 160 may be located throughout the venue (e.g., at thrill rides in a theme park) may have a connection to the theme park network server 140. Such redemption location devices 160 may pull information regarding progress toward certain rewards so that when a guest wishes to redeem a particular reward, the redemption location devices 160 can confirm the achievement and authorize the reward. The incentive redemption location devices 160 can be any venue in the theme park that sells a product or service.

In general, the video imaging device 110 may be polled for image of patron(s) 120, which may be identified and otherwise categorized by the patron categorization software 140C. If the identified patrons 120 do not leave the area, the theme park network server 140 may be programmed to consider that an indication the patrons 120 are not motivated by the incentive currently on display or otherwise made available to the patrons. When that is the case, patron categorization software may be executed again to find another subset of patrons 120B likely to respond to an incentive. If the patron 120 does leave the queue area, the incentive redemption tracking software 140B may be executed.

Execution of incentive redemption tracking software 140B may include polling incentive redemption locations 160 for an incentive redemption event by a patron 120. If no incentive redemption event is detected, the incentive redemption tracking software 140B may determine whether the day (hours of operation of the theme park) has ended. If no, the incentive redemption locations 160 may continue to be polled for an incentive redemption event. If the day has ended, all incentives in the incentive acceptance database 140D that are not flagged as “redeemed” are flagged as “not redeemed.” If an incentive redemption event is detected, the incentive redemption tracking software 140B may identify the patron characteristic(s) associated with the redeemed incentive in the incentive acceptance database 140D and flag that incentive as “redeemed.” After events are flagged in the incentive acceptance database 140D, the redemption rate for that incentive/patron characteristic combination may be updated. The queue minimization incentive targeting software 140A may then return to polling the wait time monitor.

In some embodiments, the imaging device 110 or theme park network server 140 may capture or receive patron feedback as to trigger in-line entertainment based upon wait times (e.g., as determined by wait time monitor 130) or mood (e.g., as determined by patron categorization software 140C. A prediction may be made as whether a patron 120 may leave the line based on image analysis by patron categorization software 140C, so as to offer incentives to remain in line. In such instances, the imaging device 110 may also have audio recording capabilities that may be used to predict if the patrons 120 will leave.

The incentive display device 150 may be inclusive or in communication with a smartphone (or application thereon). As such, the image and phone identifier (e.g., phone or device number) may be linked so that personalized incentives can be offered if the patron 120 is identified as having a negative mood change. The patrons 120 may also be categorized in various combinations of characteristics (e.g., not just wait time or frustration alone) to provide incentives specific to their category (e.g., children's toys).

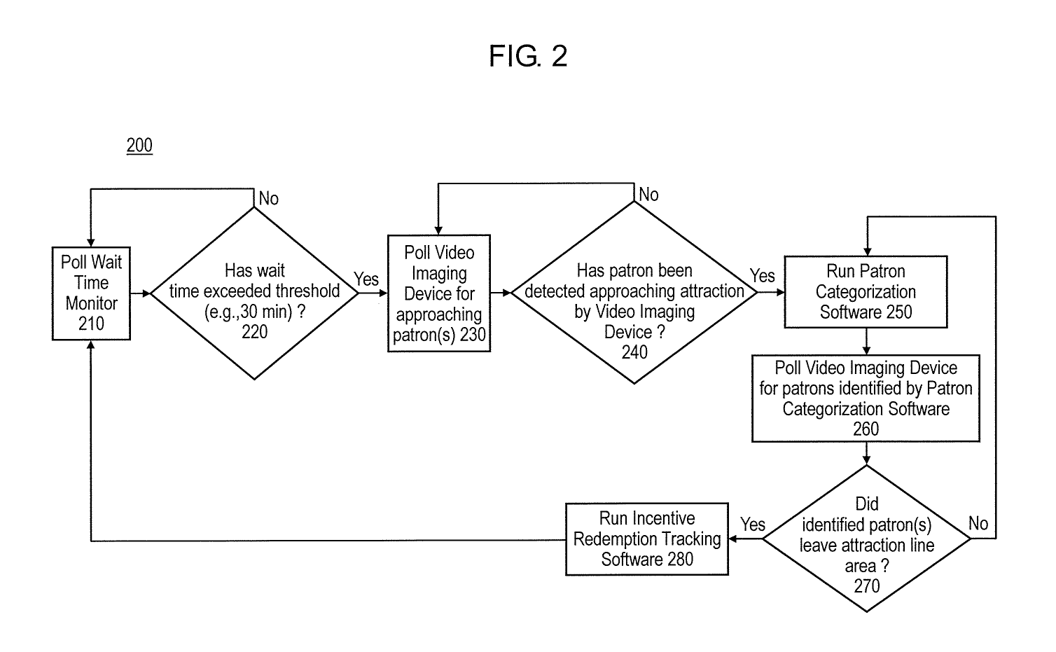

FIG. 2 is a flowchart illustrating an exemplary queue minimization method 200 for wait time avoidance. In step 210, the queue minimization incentive targeting software 140A may be continually polling the wait time monitor 130 for wait times. In step 220, it may be detected when the wait time exceeds a predetermined threshold (e.g., 30 minutes). If the wait time does not exceed the threshold, the method may return to step 210 to continue polling.

If the wait time does exceed the threshold, the method proceeds to step 230 in which the video imaging device 110 may be polled for patron(s) 120. In step 240, it may be determined whether there are patrons 120 approaching the attraction queue. If not, the method may return to step 230 to poll imaging device 110 for the presence of approaching patrons. If patrons 120 are approaching, the method may proceed to step 250 where patron categorization software 140C may be executed.

In step 260, the patron categorization software 140C may return a set of identified patron(s) 120 identified as likely to respond to an incentive that is displayed on the incentive display device. In step 270, it is determined whether the identified patrons 120 have left the attraction area. If not, the method returns to step 250.

If the patron does leave the queue area, the method proceeds to step 280 in which the incentive redemption tracking software 140A may be executed. After events are flagged in the incentive acceptance database 140D, the redemption rate for that incentive/patron characteristic combination may be updated. Then queue minimization incentive targeting software 140A may return to polling the wait time monitor 130.

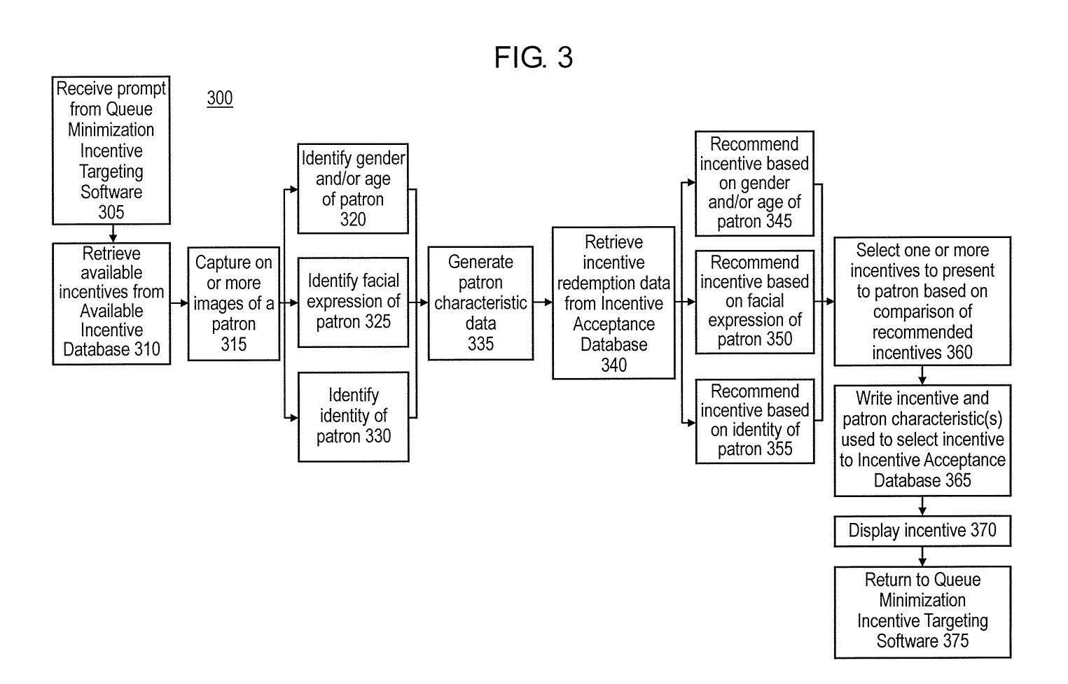

FIG. 3 is a flowchart illustrating an exemplary patron categorization method 300 for wait time avoidance. Such a method 400 may be performed by execution of the patron categorization software 140C.

In step 305, a prompt may be received from queue minimization incentive targeting software 140A (e.g., when an image has been captured). In step 310, the available incentives may be retrieved from the available incentive database 140E. In step 315, more images may be captured by imaging device 110. Facial and other types of analysis may be performed on the image. Facial analysis may include identifying the existence (or not) of a face or facial region in the captured image. Then, if a face/facial region is detected, the analysis may further include determining one or more characteristics related to the image (e.g., any or a combination of steps 320-330).

In step 320, the gender and/or age (or age range) of the patron 120 may be identified. In step 325, the facial expressions of the patron 120 may be identified. In step 330, an identity of the patron 120 may be identified. Once facial analysis has been performed, patron characteristic data may be generated in step 335 based on the analyses.

In step 340, incentive redemption data may be retrieved from incentive acceptance database 140D. A recommendation for an incentive may be made based on the respective factors analyzed with respect to gender/age (step 345), facial expression (step 350), and/or identify (step 355). The patron characteristic data may be compared, for example, to redemption rates seen in the incentive acceptance database 140D. The patron characteristic data may be compared with the incentive profiles to recommend one or more incentives based on the identified patron profile. In step 360, the patron characteristic data may be compared with the incentive profiles to recommend one or more particular selected incentives. The selection of the incentive(s) may be based on a weighing and/or ranking of various selection criteria.

In step 365, the incentive selected and patron characteristic(s) that drove the selection of that incentive may be stored in incentive acceptance database 140D. In step 370, the selected incentive is then displayed to the patron on the incentive display device (which could be a display at the exit of the ride). Then in step 375, the queue minimization incentive targeting software may continue executing.

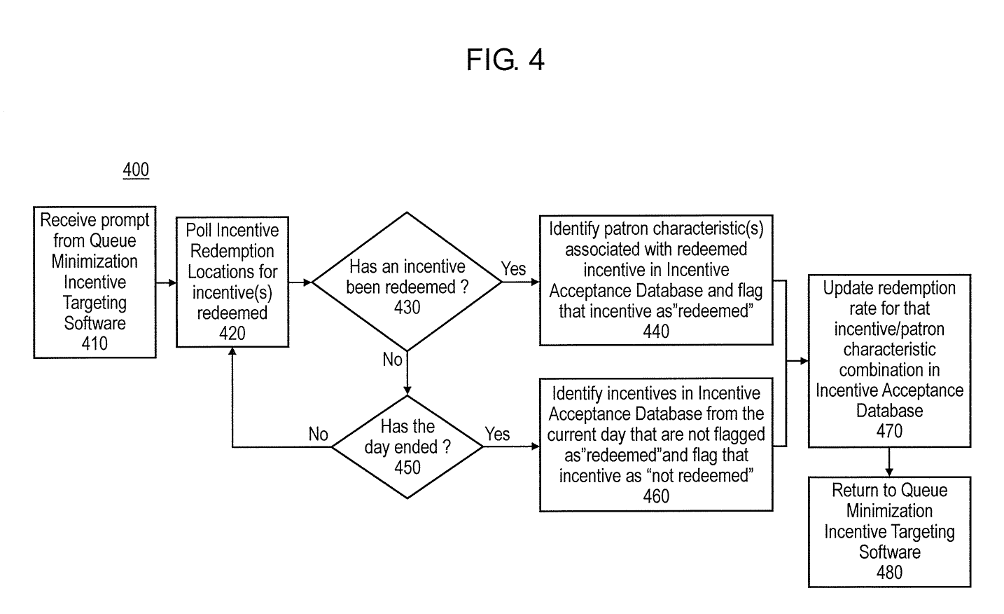

FIG. 4 is a flowchart illustrating an exemplary incentive redemption method 400 for wait time avoidance. Such a method 400 may be performed by execution of the incentive redemption software 140B.

In step 410, a prompt may be received from queue minimization incentive targeting software 140A (e.g., when a patron 120 does leave the queue area after an incentive has been displayed). In step 420, incentive redemption location devices 160 may be polled for an incentive redemption event. In step 430, it may be determined whether such an incentive redemption event has occurred.

If an incentive redemption event is detected as having occurred, the method proceeds to step 440 in which patron characteristic(s) associated with a redeemed incentive are stored, and the incentive is flagged as “redeemed” in incentive acceptance database 140D. If an incentive redemption event is not detected, the method proceeds to step 450 in which it may be determined whether the day has ended. If the day has not ended, the method returns to step 420 to continue polling for incentive redemption events. If the day has ended, the method proceeds to step 460 in which all incentives in the incentive acceptance database that are not flagged as “redeemed” are flagged as “not redeemed.”

In step 470, the redemption rate for that incentive/patron characteristic combination may be updated in incentive acceptance database 140D, and in step 480, the queue minimization incentive targeting software may continue to be executed.

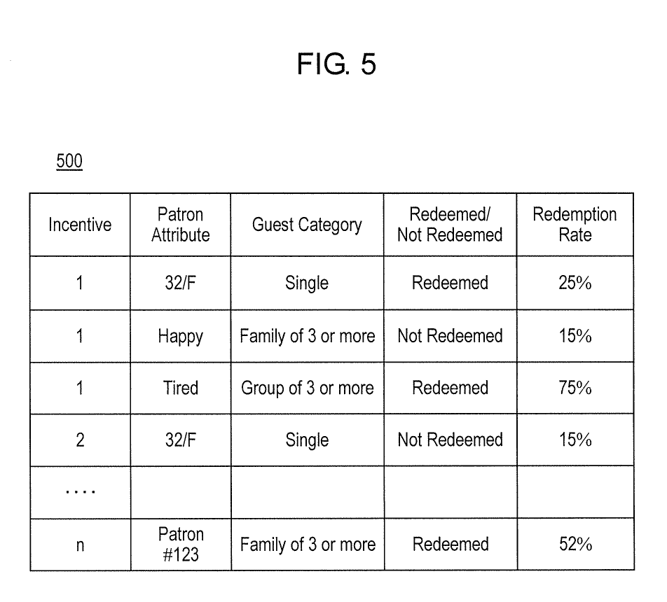

FIG. 5 illustrates an exemplary set of entries 500 in an incentive acceptance database that may be used in a system for wait time avoidance. Entries 500 track information regarding incentives, attributes of the patron 120 who was offered the respective incentive (e.g., mood as determined by patron categorization software 140C, temperature, weather, other patron profile information), guest category, redemption status (e.g., actually redeemed or not redeemed), and redemption rate.

A patron profile may be in-depth examination of the patron's attributes and preferences that may include information provided by the patron 120 in advance of attending the theme park. Such a profile can also be mined from social media profiles. The guest category may be identified by analysis of the video stream captured by imaging device 110 to determine the number of people with whom the patron 120 is traveling. A group of three or more may be differentiated from a family of three or more based on the individuals in the group. For example, three adults may be categorized as a group, while an adult traveling with two children may be categorized as a family of 3 or more. In this fashion, different incentives may be offered to different patrons 120 based upon comparing redemption rates of different incentives when either patron attribute, guest category, or both are the same. The incentive with the highest redemption rate when those variables are controlled for may then be selected for display.

FIG. 6 illustrates an exemplary computing system 600 that may be used to implement an embodiment of the present invention. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable nonvolatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A system for wait time avoidance, the system comprising:
a video imaging device configured to capture one or more images of an area; and
a server configured to receive the images captured by the video imaging device, the server comprising:
a processor configured to execute instructions stored in a computer-readable memory, execution of the instructions causing the processor to perform a method comprising:
analyzing the captured images to identify that a number of patrons in the area has met a predetermined threshold,
categorizing the patrons in the area based on a predetermined set of characteristics, and
identifying an incentive for at least one category of patrons; and
wherein the server transmits a notification regarding the identified incentive to an active communication device, thereby enabling the patrons to redeem the identified incentive.

2. The system according to claim 1, wherein the categorizing the patrons comprises:
identifying the predetermined set of characteristics of the patrons based on the captured images; and
generating patron characteristic data based on the identified set of characteristics of the patrons.

3. The system according to claim 2, wherein the predetermined set of characteristics includes at least one of gender, age, facial expression, and identity.

4. The system according to claim 2, wherein the identifying the incentive comprises: identifying patron characteristics associated with redeemed incentives to generate incentive acceptance data; and
recommending an incentive to the patrons based on the identified set of characteristics of the patrons and incentive acceptance data.

5. The system according to claim 4, wherein the incentive acceptance data further comprises information associated with incentives offered to patrons having a given set of characteristics, and information relating to whether the offered incentives were redeemed.

6. The system according to claim 4, wherein the recommending the incentive comprises selecting one or more incentives based on a redemption acceptance rate for a given incentive with respect to the set of characteristics of the patrons to which the given incentive was offered.

7. The system according to claim 1, wherein the video monitoring device comprises a camera.

8. The system according to claim 1, wherein the method further comprises estimating a current wait time associated with the area based on the captured images.

9. A method for reducing wait time, the method comprising:
analyzing, using a server, one or more images of an area to determine whether a number of patrons in an area has met a predetermined threshold;
categorizing, using the server, the patrons in the area based on a predetermined set of characteristics;
identifying, using the server, an incentive for at least one category of patrons; and
offering, using an active communication device configured to communicate with the server, the identified incentive to the at least one category of patrons, thereby moving the patrons choosing to redeem the offered incentive away from the area to reduce the wait time.

10. The method of claim 9, the categorizing the patrons comprises:
identifying a predetermined set of characteristics of the patrons based on the captured images; and generating patron characteristic data based on the identified set of characteristics of the patrons.

11. The method of claim 10, wherein the identifying the incentive comprises: identifying patron characteristics associated with redeemed incentives to generate incentive acceptance data; and recommending an incentive to the patrons based on the identified set of characteristics of the patrons and incentive acceptance data.

12. The method of claim 10, wherein the recommending the incentive comprises selecting one or more incentives based on a redemption acceptance rate for a given incentive with respect to the set of characteristics of the patrons to which the given incentive was offered.

13. The method of claim 9, further comprising estimating a current wait time associated with the area based on the captured images.
